(19) United States
(12) Patent Application Publication
(10) Pub. No.: US 2006/0196970 A1
(43) Pub. Date: Sep. 7, 2006

(54) SPRAY NOZZLE FOR SPRAY FORMING A REACTANT MIXTURE APPLIED WITH A FLAT FAN SPRAY

(75) Inventors: Douglas A. Taylor, Saginaw, MI (US); Ian S. Williams, Howell, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 10/906,791

(22) Filed: Mar. 7, 2005

(51) Int. Cl. B05B 7/04; F23D 11/40; A62C 31/00; F23D 11/16

(52) U.S. Cl. 239/398; 239/419; 239/433

(57) ABSTRACT

A method of spray forming articles with a nozzle that sprays in a flat fan-shaped spray pattern. The process may be used to spray form articles having a skin formed from a polyurethane composition. Repeated passes of the nozzle partially overlap to apply a deposit having a relatively consistent thickness in a series of overlapping paths. A primary flat fan-shaped spray is flanked by a pair of secondary sprays that are outboard of the primary spray. The secondary sprays facilitate feathering the edges of adjacent deposits to provide a skin having a relatively consistent thickness.

### BACKGROUND OF THE INVENTION

1. Field of the Invention

The present invention relates to spray forming articles using a spray nozzle that directs a flat fan-shaped spray pattern.

2. Background Art

Spray forming articles with reactant elastomer mixtures, such as polyurethane, is a relatively new process that holds substantial promise for manufacturing high quality, durable parts. Parts that may be made with the polyurethane spray forming process include automotive interior parts as well as other parts. Some automotive interior parts that may be made using a polyurethane skin or polyurethane layer include instrument panel covers, console covers, inner door panels, glove box covers, floor mats, steering column covers, knee bolsters, and the like. Structural inserts and padding may be assembled to or inserted in the polyurethane skin to complete the interior part.

Earlier attempts to manufacture polyurethane parts by a spray forming process have required expensive spray nozzle tips that are used to form a conical spray pattern. Generally, polyurethane spray forming process nozzles have an internal mixing chamber that have a plurality of angularly oriented injection ports that are used to develop turbulence within the mixing chamber. These elaborate spray nozzle tips, in addition to being expensive, require frequent maintenance and cleaning to assure proper performance. A conical spray pattern may yield a slightly cupped spray deposit in cross-section with a portion near the outer edges of the spray deposit being thicker than the central portion.

Conical sprays generally result in higher quantities of over spray. Over spray can be in the range of 15% of the volume sprayed. Accumulations of over spray outside the useable area of a mold wastes material, burdens air handling systems and creates an unsightly mess inside spray booths.

Prior art conical spray patterns require high pressure spray equipment that is designed to operate at 1000 to 2000 psi. Conical spray patterns at such pressures may be used to spray polyurethane at a rate of 16 to 24 grams per second. Processes requiring higher pressures generally require higher capital investments. An application rate of 16 to 24 grams per second is the norm but higher productivity could be obtained if the spray application rate could be increased without increasing pressure, velocity and turbulence of the spray.

Simpler spray applicator nozzles have been tested in an effort to develop a spray applicator nozzle that produces a flat fan spray pattern. These nozzles were provided with a tip that has a slit formed by two intersecting arcs for producing the flat fan spray. Testing of this nozzle in a spray forming operation resulted in a flat fan spray that has thick edge portions that are separated from a relatively uniform central portion by thin areas. It is believed that this inconsistent spray thickness is caused by variation in the laminar flow pattern through the nozzle wherein the central laminar flow rate is greater than the peripheral laminar flow rate.

To make a continuous skin, several spray passes must be applied next to each other. Increased accumulation of the spray deposit on the outer edges of each deposit made by a spray pass can result in a ribbed appearance on the back side of the spray applied layer. While the ribbed appearance is not generally visible on the mold side or exterior surface of a part, in some instances it may be detectable as an area of different thickness and possibly different hardness compared to the other parts of the skin. Skin thickness variations may cause problems relating to attachment to rigid inserts and retainers and may also adversely impact the uniformity of a foam padding layer thickness.

These and other problems are addressed by applicants' invention as summarized below.

### SUMMARY OF THE INVENTION

According to one aspect of the present invention, a spray applicator for spraying polyurethane that is used to spray form an article is disclosed that provides a more uniform and consistent skin. The spray applicator includes an applicator body having an internal cavity that receives at least two polyurethane forming components. The polyurethane forming components are mixed in an internal mixing chamber to form a polyurethane mixture that is dispensed through a nozzle defining an elongated slit-type of spray opening that dispenses the polyurethane mixture. A concentrating insert is assembled to the applicator body immediately upstream from the nozzle. The concentrating insert has a hollow central cylindrical opening, or pre-orifice. The insert concentrates the polyurethane mixture in the interior portion of the spray pattern and a reduced volume of the polyurethane mixture is applied at the lateral end portions of the spray pattern.

According to other aspects of the invention, the nozzle may spray the polyurethane composition in a flat fan shaped pattern onto a mold surface. A single swath of polyurethane may be sprayed on the mold surface initially with additional spray applications being made in a predetermined path to create a skin layer with multiple overlapping swaths being applied in multiple passes of the nozzle relative to the mold. The lateral end portions of the spray pattern of adjacent swaths overlap to form a skin layer that has a relatively consistent thickness.

Other aspects of the invention relate to the structural features of the concentrating ring or insert. The concentrating insert, or ring, may be retained by a sealing member that forms a seal between the ring and the nozzle. Alternatively, the ring may be a hard metal insert. The sealing member may be a plastic washer. A collar may be used to secure the nozzle and concentrating insert to the applicator body. The sealing member forms a seal between the concentrator insert and the nozzle and is held in place by the collar.

The polyurethane composition may be a two-component aromatic polyurethane mixture of polyol and isocyanate that are internally mixed in the spray applicator. The spray applicator may have a helical static mixing element that mixes the polyol with the isocyanate prior to being sprayed by the spray nozzle.

According to another aspect of the present invention, a spray applicator for spraying a reactant mixture to form an article in conjunction with a mold is provided. The spray applicator comprises a mix tube having a plurality of inlets for a plurality of components and an outlet for dispensing the reactant mixture that is formed as a mixture of the plural components. A nozzle for spraying the reactant mixture is in fluid flow communication with the outlet of the mix tube. The nozzle defines an interior cavity and has an elongated slit spray opening. A collar secures the nozzle to the mix tube. A flow restricting ring is disposed upstream of the elongated slit spray opening in the interior cavity of the nozzle. The flow restricting ring is retained by a sealing washer within the collar. The reactant mixture flows from the mix tube through the flow restricting ring and out of the nozzle in a controlled spray pattern.

According to other aspects of the invention, the flow restricting ring defines an aperture that focuses the flow of reactant mixture in a central portion of the nozzle. The controlled spray pattern may be a flat fan spray pattern wherein the polyurethane mixture is concentrated in the interior portion of the spray pattern and a reduced volume of the polyurethane mixture is supplied at the lateral end portions of the spray pattern. The nozzle tip has a slit opening formed by two intersecting arcuate edges extending across a central portion of the tip. The nozzle may be oriented at an oblique angle relative to the mix tube that directs the reactant mixture spray in a selected direction.

According to another aspect of the present invention, the ratio of the area of the opening in the flow restricting ring to the area of the slit spray opening is controlled to provide a relatively even spray pattern. The ratio of the area of the opening in the flow restricting ring to the area of the slit spray opening may be 1 to 0.4-0.6, or more particularly about 1 to 0.5.

These and other aspects of the invention will be readily apparent in view of the attached drawings and following detailed description.

### BRIEF DESCRIPTION OF THE DRAWINGS

FIG. 1 is a diagrammatic perspective view of a spray forming process utilizing a nozzle having a concentrating insert in accordance with the present invention that provides a flat fan spray pattern;

FIG. 2 is a cross-sectional view taken along the line 2-2 in FIG. 1;

FIG. 3 is a cross-sectional view of the spray deposited by the process illustrated in FIG. 1 in a series of passes;

FIG. 4 is a cross-sectional view of a spray applicator nozzle having a flow restricting ring, or concentrator insert;

FIG. 5 is an exploded perspective view of a spray applicator nozzle having a flow restricting ring;

FIG. 6 is a diagrammatic cross-sectional view of a spray applicator nozzle that does not have a flow restricting ring and the resultant spray and application pattern;

FIG. 7 is a diagrammatic cross-sectional view of a spray applicator nozzle having a flow restricting ring and the resultant spray and application pattern; and

FIG. 8 is an end view of the nozzle shown in FIG. 5.

### DETAILED DESCRIPTION OF THE PREFERRED EMBODIMENTS

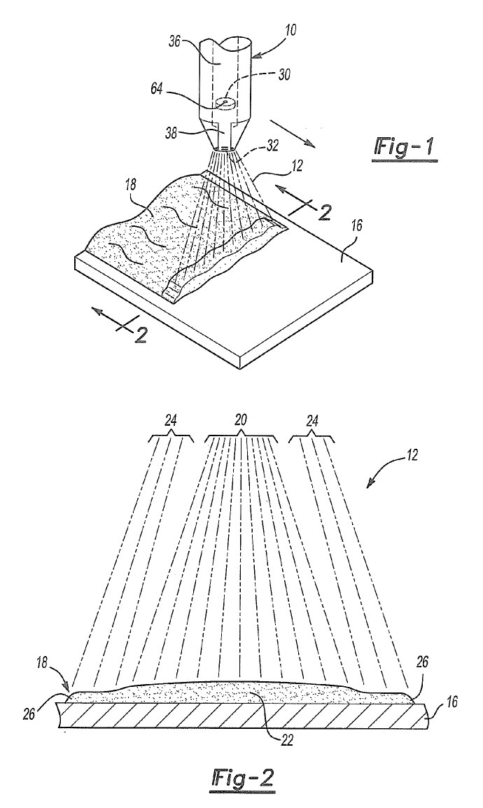

Referring to FIG. 1, a spray applicator nozzle 10 is shown as its sprays a reactant mixture 12 of a polyurethane composition. The reactant mixture 12 is sprayed on a mold 16 to form a skin 18 composed of the polyurethane reactant mixture 12. The mold 16, as shown in FIG. 1, is a flat plate but it should be understood that the mold could include a contoured surface including, for example, convex and concave areas corresponding to the shape of a vehicle interior part.

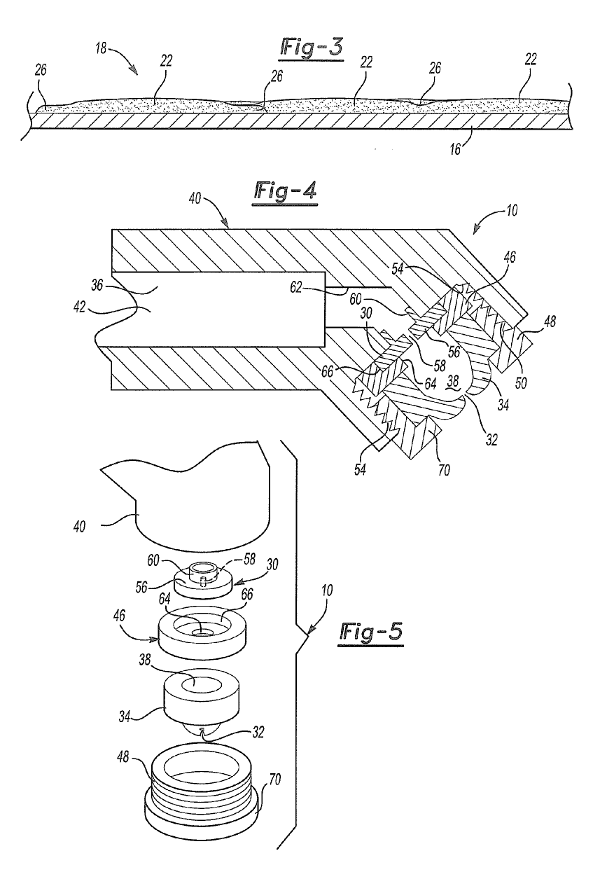

Referring to FIGS. 1 and 2, a central spray 20 forms a principal portion 22 of the skin 18 with a relatively consistent thickness. Spray edges 24 form tapered edge portions 26 on opposite sides of the principal portion 22. The tapered edge portions 26 are intended to be layered with tapered edge portions of adjacent spray swaths and thereby provide a skin 18 of relatively constant thickness in conjunction with adjacent spray swaths, as shown in FIG. 3. A skin having a smooth exterior surface without distinct ridges or ribs should be understood to be one having a relatively constant thickness.

Referring back to FIG. 1, a flow restriction ring 30, or concentrator, is disposed in the spray applicator nozzle 10 upstream in the flow of the polyurethane mixture relative to a slit 32 formed in a nozzle tip 34 of the spray applicator nozzle 10. A mixing chamber 36 is provided upstream from the flow restriction ring 30 and may include a static mixing element (not shown in FIG. 1). An interior cavity 38 is provided in the nozzle tip 34 between the flow restriction ring 30 and the slit 32 in the nozzle tip 34.

Referring to FIG. 4, an applicator tool 40 is shown that includes a static mixer 42 that is used to mix polyurethane forming components comprising polyol and isocyanate prior to supplying the reactant mixture to the flow restriction ring 30 and then to the nozzle tip 34. The flow restriction ring 30 is held in place by a retainer 46 comprising a washer-like structure that is engaged by a collar 48 of the spray nozzle 10. The collar 48 has a threaded outer diameter 50 and is received in a threaded end opening 54 of the spray nozzle 10.

The flow restriction ring 30 in the illustrated embodiment includes a disk-shaped portion 56 that defines a cylindrical opening 58. A cylindrical ring 60 is also provided on the flow restriction ring 30. The cylindrical ring 60 may be received in a passageway 62 through which reactant mixture is supplied from the mixing chamber 36 to the spray nozzle 10.

The retainer 46 includes a central opening 64 that is coaxial with the cylindrical opening 58 in the flow restriction ring 30. A counterbore opening 66 is provided in the retainer 46 that receives at least a portion of the flow restriction ring 30.

The collar 48 includes a shoulder 70 that retains the nozzle tip 34 and the spray nozzle 10. The collar 48 establishes a seal by applying pressure to the nozzle tip 34, retainer 46, and flow restriction ring 30. The collar 48 is tightened by the threaded connection between the threaded outer diameter 50 and threaded opening 54 in the spray nozzle 10.

Referring to FIG. 5, the structure of the spray applicator nozzle 10 is shown in greater detail. The spray nozzle 10 is received by the applicator tool 40. The collar 48 engages the nozzle tip 34 with a shoulder 70 bearing upon the nozzle tip 34. Nozzle tip 34 includes a slit 32 formed in the nozzle tip 34. The nozzle tip 34 engages the retainer 46 and defines an interior cavity 38 in conjunction with the retainer 46. The retainer 46 defines a central opening 64 and a counterbore opening 66 in which the flow restriction ring 30 is at least partially received. Flow restriction ring 30 includes a disk-shaped portion 56 that defines a cylindrical opening 58. A cylindrical ring 60 is provided on the flow restriction ring that is coaxial with the opening 58 and aligns the flow restriction ring with the passageway 62 in the applicator tool through which the reactant mixture 12 is supplied to the nozzle 10.

Referring to FIG. 6, a prior art fan spray nozzle 80 is diagrammatically illustrated. The fan spray nozzle 80 is provided with a reactant mixture, the flow of which is represented by laminar flow vector arrows 82. The rate of laminar flow through the fan spray nozzle 80 is greatest in the central portion of the nozzle 80 with the rate of flow being reduced progressively as it approaches the peripheral edges of the nozzle 80. Laminar flow characteristics through the fan spray nozzle 80 are believed to contribute to the formation of heavy fingers of spray 84 that are separated by areas of thin spray 86 from the primary application spray 88. The heavy fingers of spray 84 result in heavy edge deposits 90 that are separated by thinner deposits 92 from the primary deposit 94 of the skin 18. The heavy edges in the flat spray pattern make it necessary to overlap adjacent spray swaths to a greater extent than if a smooth edge tapered spray pattern is provided. Increasing the degree of overlap between adjacent passes necessitates application of a larger amount of material to cover or smooth inconsistencies in the spray pattern.

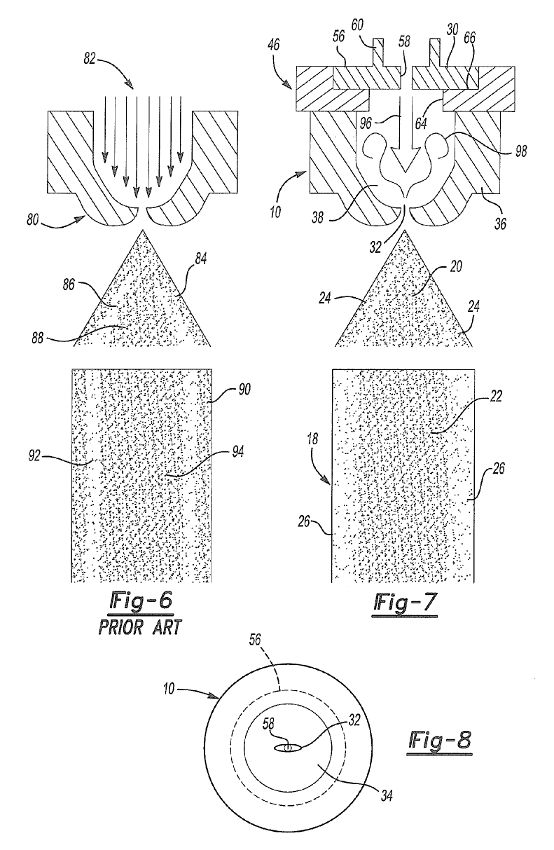

Referring to FIG. 7, a spray applicator nozzle 10 including a flow restriction ring 30 is diagrammatically illustrated with its associated spray pattern and spray deposit. The flow restriction ring 30 is comprised of the disk-shaped portion 56 that defines the cylindrical opening 58 through which the reactant mixture 12 is directed into an interior cavity 38 defined by the nozzle 10. A focused internal flow arrow 96 illustrates the relatively linear and uniform laminar flow pattern produced by the flow restriction ring 30. It is also understood that a limited amount of turbulence may exist within the interior cavity 38 of the nozzle 10 that is diagrammatically represented by the curved lines 98 inside the interior cavity 38. As the reactant mixture 12 flows through the cylindrical opening 58, it is focused in the central portion of the slit 32 formed in the nozzle 10. The spray produced includes a central spray 20 and tapered spray edges 24. The skin 18 produced has a central portion 22 of relatively consistent thickness and two tapered edge portions 26 on the outer edges of the principal portion 22. The tapered edge portions 26 may be partially reticulated with holes, or gaps, being filled in by an adjacent spray forming pass.

Referring to FIG. 8, an end view of the nozzle is provided to illustrate the relationship of the slit 32 in the nozzle tip 34 relative to the cylindrical opening 58 formed in the disk-shaped portion 56 of the flow restriction ring 30. The slit 32 is preferably formed by intersecting arcuate edges.

The relationship of slit 32 to the cylindrical opening 58 may be analyzed in terms of an equivalent orifice diameter (EOD). The relationship of the EOD of the cylindrical opening to the EOD of the slit and may vary depending upon the flow rate of the reactant mixture. For example, at flow rates of 15 grams per second, an area ratio of 0.52 produced an acceptable skin having a principal portion 22 with a constant thickness and tapered edge portions 26. It is believed that an area ratio of 1:0.4 to 0.6 may also produce acceptable skins at a flow rate of approximately 15 grams per second.

The flow rate may be expressed as:
Q=AV

wherein:
Q=the flow rate
A=the area
V=velocity

The area of the cylindrical opening 58 in the flow restriction ring 30 is approximately twice the size of the area of the slit 32 formed in the nozzle tip 34. The diameter of the cylindrical opening 58, as tested, is between 0.12-0.36 inches.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A spray applicator for spraying polyurethane to spray form an article:
an applicator body having an internal cavity that receives at least two polyurethane forming components that are mixed in an internal mixing chamber to form a polyurethane mixture that is dispensed through an orifice;
a nozzle defining an elongated slit spray opening that dispenses the polyurethane mixture provided to the nozzle from the internal mixing chamber;
a concentrating insert is assembled to the applicator body immediately upstream from the nozzle, the concentrating insert having a hollow central cylindrical opening, wherein the polyurethane mixture is concentrated in the interior portion of the spray pattern and a reduced volume of the polyurethane mixture is applied at the lateral end portions of the spray pattern.

2. The spray applicator of claim 1 wherein the nozzle sprays the polyurethane composition in a flat fan shaped pattern onto a mold surface to apply a single swath of polyurethane to the mold surface, the nozzle and mold surface are moved relative to each other in a path to create a skin layer with multiple partially overlapping swaths being applied in multiple passes of the nozzle relative to the mold, wherein the lateral end portions of the spray pattern of adjacent swaths are overlapped to form a skin layer that has a substantially consistent thickness.

3. The spray applicator of claim 1 wherein the concentrating insert is a rigid ring that is retained by a sealing member that forms a seal between the ring and the nozzle.

4. The spray applicator of claim 3 wherein the ring is a hard metal insert.

5. The spray applicator of claim 3 wherein the sealing member is a plastic washer.

6. The spray applicator of claim 1 further comprising a collar securing the nozzle and the concentrating insert to the applicator body.

7. The spray applicator of claim 6 further comprising a sealing member forming a seal between the concentrator insert and the nozzle that is held in place by the collar.

8. The spray applicator of claim 1 wherein the polyurethane composition is a two component aromatic polyurethane mixture of polyol and isocyanate that are internally mixed in the spray applicator having a helical static mixing element that mixes the polyol and isocyanate prior to being sprayed by the spray nozzle.

9. A spray applicator for spraying a reactant mixture to form an article in conjunction with a mold comprising:
a mix tube having a plurality of inlets for a plurality of components and an outlet for dispensing the reactant mixture that is formed as a mixture of the plural components;
a nozzle for spraying the reactant mixture that is in fluid flow communication with the outlet of the mix tube, the nozzle defining an interior cavity and having an elongated slit spray opening;
a collar securing the nozzle to the mix tube; and
a flow restricting ring disposed upstream of the elongated slit spray opening in the interior cavity of the nozzle and being retained by a sealing washer within the collar, wherein the reactant mixture flows from the mix tube, through the flow restricting ring and out of the spray applicator in a controlled spray pattern.

10. The spray applicator of claim 9 wherein the flow restricting ring defines an aperture that focuses the flow of reactant mixture in a central portion of the nozzle.

11. The spray applicator of claim 9 wherein the controlled spray pattern is a flat fan spray pattern, wherein the polyurethane mixture is concentrated in the interior portion of the spray pattern and a reduced volume of the polyurethane mixture being applied at the lateral end portions of the spray pattern.

12. The spray applicator of claim 9 wherein the nozzle has a tip that has a slit opening formed by two intersecting arcuate edges extending across a central portion of the tip.

13. The spray applicator of claim 9 wherein the nozzle is oriented at an oblique angle relative to the mix tube that directs the reactant mixture spray in a selected direction.

14. The spray applicator of claim 9 wherein the reaction mixture is a two component aromatic polyurethane mixture of polyol and isocyanate that are internally mixed in the mix tube that has a static helical mixing element that mixes the polyol and isocyanate prior to flowing through the flow restricting ring.

15. The spray applicator of claim 9 wherein the ratio of the area of the opening in the flow restricting ring and the area of the slit spray opening is controlled to provide a relatively even spray pattern.

16. The spray applicator of claim 15 where the ratio of the area of the opening in the flow restricting ring to the area of the slit spray opening is 1:0.4-0.6.

17. The spray applicator of claim 15 where the ratio of the area of the opening in the flow restricting ring to the area of the slit spray opening is about 1:0.5.
